(19) United States
(12) Patent Application Publication
(10) Pub. No.: US 2025/0154812 A1
(43) Pub. Date: May 15, 2025

(54) Locking Hinge Assemblies for Use on Vehicles

(71) Applicant: Arctic Cat Inc., Thief River Falls, MN (US)

(72) Inventor: Jordan Aubrey Renfro, Thief River Falls, MN (US)

(73) Assignee: Arctic Cat Inc., Thief River Falls, MN (US)

(21) Appl. No.: 18/939,301

(22) Filed: Nov. 6, 2024

Related U.S. Application Data
(60) Provisional application No. 63/599,549, filed on Nov. 15, 2023.

(51) Int. Cl. E05D 11/10; B62D 33/03; B62D 33/037

(52) U.S. Cl. CPC E05D 11/1014; B62D 33/03; B62D 33/037; E05Y 2201/684; E05Y 2900/544

(57) ABSTRACT

A locking hinge assembly for a vehicle includes a hinge base coupled to a base component of the vehicle. The hinge base defines a vertical channel and a horizontal channel. The vertical channel is perpendicular to the horizontal channel. The locking hinge assembly also includes a hinge tongue coupled to a pivotable component of the vehicle. The hinge tongue is moveable between various positions including a closed position and an open position. The hinge tongue is received by the vertical channel of the hinge base in the closed position. The hinge tongue is received by the horizontal channel of the hinge base in the open position.

### CROSS-REFERENCE TO RELATED APPLICATIONS

The present application claims the benefit of U.S. Provisional Application No. 63/599,549, filed Nov. 15, 2023, the entire contents of which is hereby incorporated by reference.

### TECHNICAL FIELD OF THE DISCLOSURE

The present disclosure relates, in general, to hinges for use on vehicles and in particular, to locking hinge assemblies coupling a base component of a vehicle such as a cargo box floor to a pivotable component of the vehicle such as a bedside gate to allow movement of the pivotable component through a range of positions including locked closed and open positions.

### BACKGROUND

Off-road vehicles are popular land vehicles used to transport people, cargo and accessories. Such off-road vehicles include all-terrain vehicles (ATV), light utility vehicles (LUV), side-by-side vehicles (SxS), utility-terrain vehicles (UTV), recreational off-highway vehicles (ROV) and multipurpose off-highway utility vehicles (MOHUV), to name a few. Certain off-road vehicles are primarily designed for utility applications and may offer high ground clearance, low gear ratios for towing, racks for hauling large loads, large cargo boxes and/or high payload capacity. Other off-road vehicles are primarily designed for recreational or sport applications and may offer high performance engines as well as safety features including rollover protection, hard tops, windshields and/or cab enclosure features such as body panels that restrict occupant egress in the event of a rollover. While some off-road vehicles have handlebar steering and motorcycle-style straddle seating, many off-road vehicles utilize automobile-style controls such as a steering wheel and foot pedals, and have side-by-side seating for the occupants. Off-road vehicles commonly have front and/or rear suspensions including shock absorbers that damp vibrations and reduce the rocking and swaying experience of the occupants making such off-road vehicles suitable for travel over a diversity of terrains, in various conditions and at an array of speeds.

Vehicles typically include a variety of doors, gates, lids, panels or other pivotable components for a large swath of applications. For example, many off-road vehicles have a rear cargo box with a pivotable tailgate for transporting large items and/or materials. Other non-limiting examples of pivotable components include storage compartment doors such as a glove compartment door or an exterior storage compartment door, fuel tank inlet covers, toolless access panel doors, pivotable windshields, pivotable radiators, passenger doors and convertible passenger seats. Because vehicles, especially off-road vehicles, often encounter uneven terrain, onboard doors, gates, lids, panels and other pivotable components are susceptible to shaking, rattling and other undesired movement, which may dislodge such components from their intended positions. Accordingly, a need has arisen for improved hinges for vehicle doors, gates, lids and other pivotable components that are lockable into closed and open positions to maintain the desired position(s) of the component(s) while the vehicle is moving.

### SUMMARY

In a first aspect, the present disclosure is directed to a locking hinge assembly for a vehicle. The locking hinge assembly includes a hinge base coupled to a base component of the vehicle. The hinge base defines a vertical channel and a horizontal channel. The vertical channel is perpendicular to the horizontal channel. The locking hinge assembly may also include a hinge tongue coupled to a pivotable component of the vehicle. The hinge tongue is moveable between various positions including a closed position and an open position. The hinge tongue is received by the vertical channel of the hinge base in the closed position. The hinge tongue is received by the horizontal channel of the hinge base in the open position.

In some embodiments, the vehicle may include a cargo box including a floor and a gate. In such embodiments, the base component may be the floor of the cargo box and the pivotable component may be the gate of the cargo box. In certain embodiments, the gate may be a bedside gate or a tailgate. In some embodiments, the hinge base may include first and second vertical side walls at least partially defining the vertical and horizontal channels. In certain embodiments, the hinge base may include a horizontal stopping plate bridging the first and second side walls, the stopping plate partially defining the horizontal channel to secure the hinge tongue in the open position. In some embodiments, the first and second side walls may each define a guide slot extending along the vertical and horizontal channels of the hinge base. In such embodiments, the hinge tongue may include one or more guide pins slidably engaged with the guide slots, the one or more guide pins slidable along the guide slots as the hinge tongue moves between the various positions. In certain embodiments, each guide slot may include a substantially linear horizontal section extending along the horizontal channel of the hinge base, a substantially linear vertical section extending along the vertical channel of the hinge base and a substantially linear diagonal section connecting the horizontal and vertical sections. In some embodiments, each guide slot may have a terminal end forming a locking notch, the locking notches receiving the one or more guide pins in the open position of the hinge tongue, thereby securing the pivotable component in the open position.

In certain embodiments, the hinge base may include a locking latch disposed in the horizontal channel. In such embodiments, the hinge tongue may include a locking pin, the locking latch receiving the locking pin in the open position of the hinge tongue to secure the pivotable component in the open position. In some embodiments, the hinge base may include a corner bracket partially defining the horizontal channel. In such embodiments, the locking latch may project from the corner bracket. In certain embodiments, the locking latch may be at least partially formed from an elastomeric material. In some embodiments, the hinge base may include a corner bracket configured to secure the hinge base to an edge of the base component. In certain embodiments, the corner bracket may include vertical and horizontal base walls, the vertical base wall partially defining the vertical channel, the horizontal base wall partially defining the horizontal channel. In some embodiments, the vertical channel may be defined by the corner bracket, vertical side walls and a cover wall to form a closed channel with a rectangular cross section and an open top end.

In a second aspect, the present disclosure is directed to an off-road vehicle including a frame assembly, a seating assembly coupled to the frame assembly and a cargo box coupled to the frame assembly aft of the seating assembly. The cargo box includes a floor and a gate. The off-road vehicle has a locking hinge assembly including a hinge base coupled to the floor of the cargo box. The hinge base defines a vertical channel and a horizontal channel. The vertical channel is perpendicular to the horizontal channel. The locking hinge assembly may also include a hinge tongue coupled to the gate of the cargo box. The hinge tongue is moveable between various positions including a closed position and an open position. The hinge tongue is received by the vertical channel of the hinge base in the closed position. The hinge tongue is received by the horizontal channel of the hinge base in the open position.

In some embodiments, the gate may include a plurality of gates including a tailgate, a left bedside gate and a right bedside gate. In such embodiments, the locking hinge assembly may include a plurality of locking hinge assemblies and each gate may be coupled to the floor of the cargo box via one or more of the locking hinge assemblies. Also in such embodiments, the cargo box may be convertible between a box in the closed positions of the locking hinge assemblies and a flatbed in the open positions of the locking hinge assemblies. In certain embodiments, the hinge tongue may include a tongue bracket and a tongue base. In such embodiments, the tongue bracket may be coupled to the gate of the cargo box and the tongue base may be received by the vertical or horizontal channels of the hinge base. In some embodiments, the tongue base may include vertical side walls at least partially defining a tongue base channel. In such embodiments, the tongue base may include a locking pin disposed in the tongue base channel. In certain embodiments, the tongue base may have a smaller cross section than the vertical or horizontal channels.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1F are schematic illustrations of an off-road vehicle utilizing locking hinge assemblies in accordance with embodiments of the present disclosure;

FIGS. 2A-2D are various views of a locking hinge assembly in accordance with embodiments of the present disclosure;

FIGS. 3A-3E are isometric views of a locking hinge assembly in a sequential operating process for moving from a closed position to an open position in accordance with embodiments of the present disclosure;

FIGS. 4A-4B are various views of a locking hinge assembly showing a locking latch and locking pin engagement mechanism in accordance with embodiments of the present disclosure;

FIGS. 5A-5C are side views of a locking hinge assembly in a sequential operating process for moving a pivotable component from a closed position to an open position in accordance with embodiments of the present disclosure; and

FIGS. 6A-6B are cross-sectional side views of a locking hinge assembly in a sequential operating process for moving a cargo box gate from a closed position to an open position in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

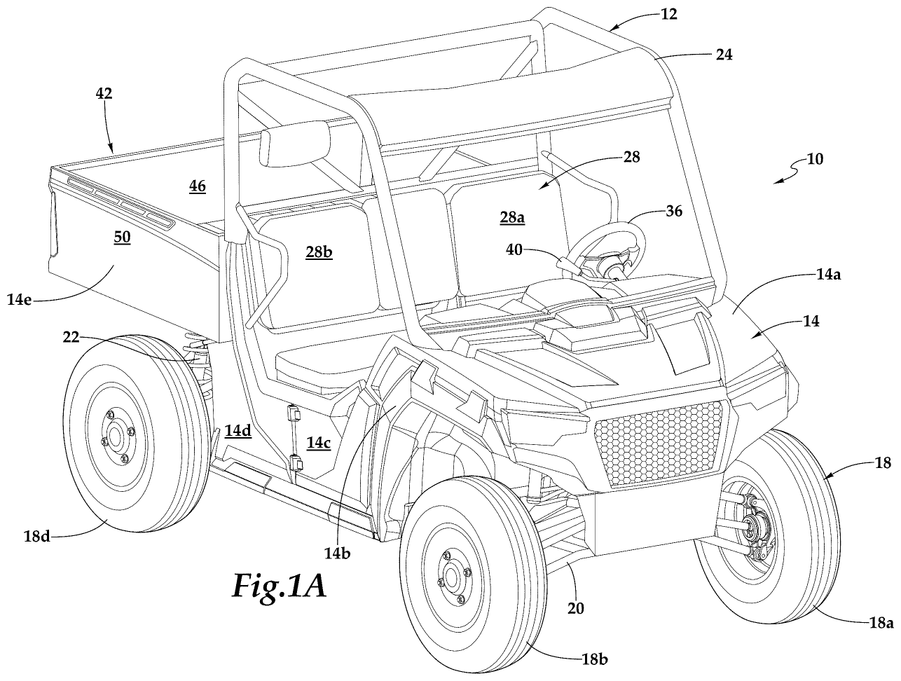

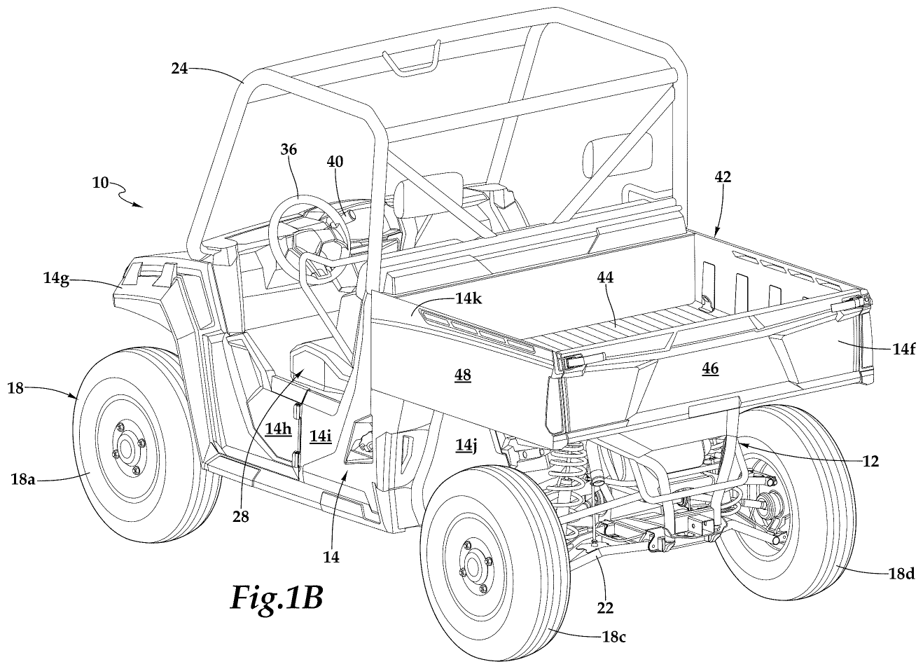

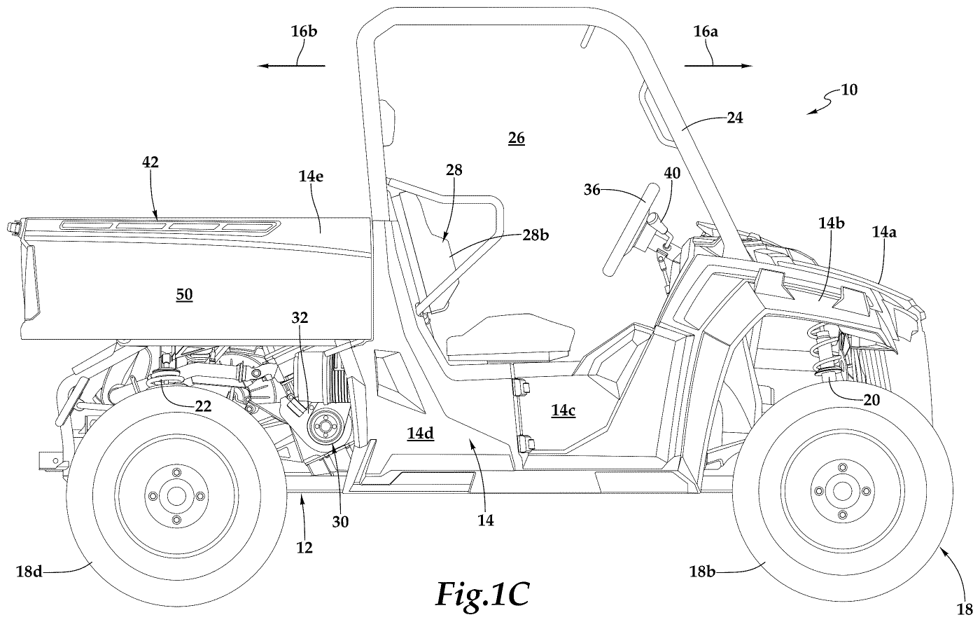

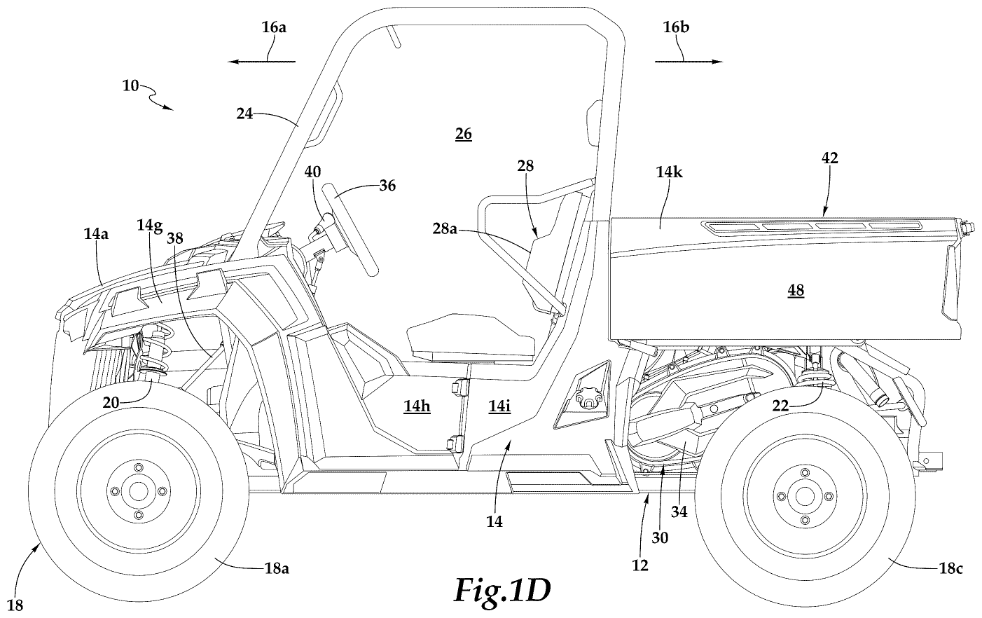

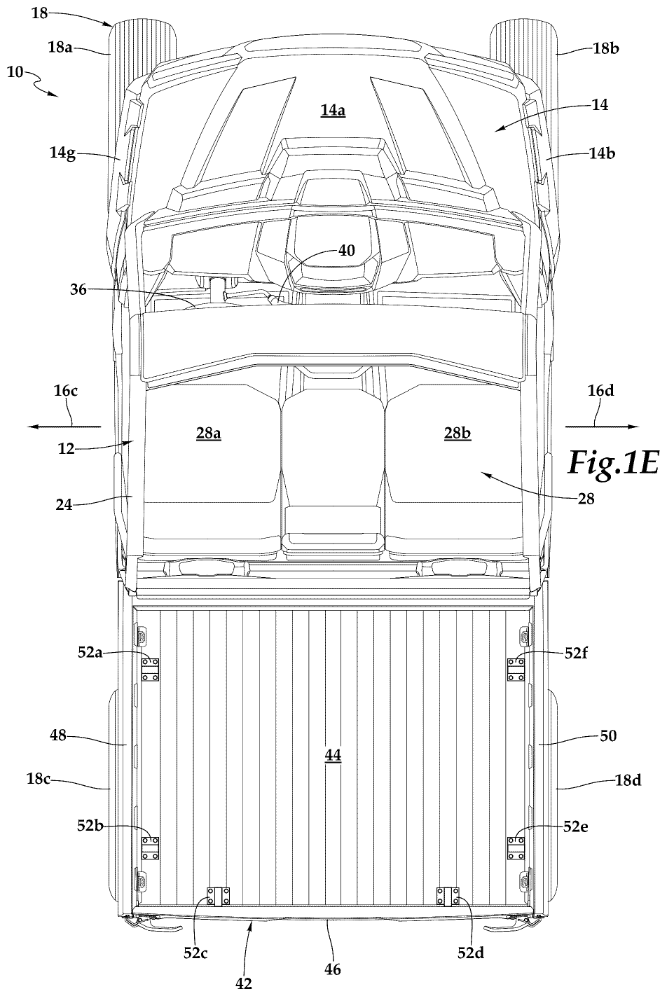

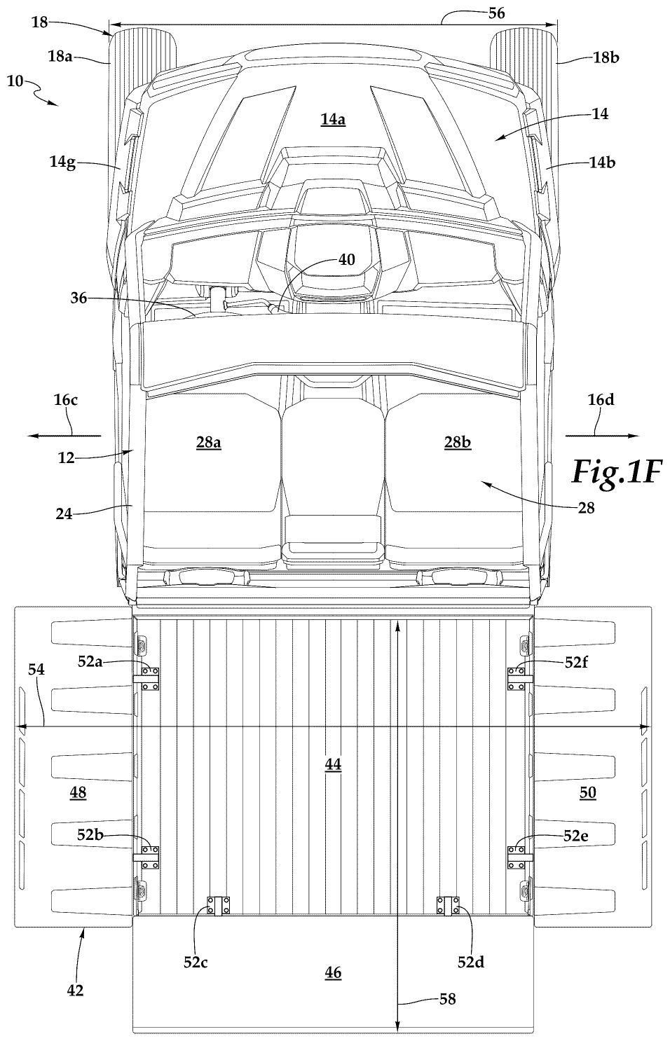

Referring to FIGS. 1A-1F in the drawings, a land vehicle depicted as an off-road vehicle utilizing locking hinge assemblies is schematically illustrated and generally designated 10. In the illustrated embodiment, off-road vehicle 10 is a side-by-side vehicle. In other embodiments, off-road vehicle 10 may be an all-terrain vehicle, a light utility vehicle, a utility-terrain vehicle, a recreational off-highway vehicle, a multipurpose off-highway utility vehicle or the like. Structural support for off-road vehicle 10 is provided by frame assembly 12, on or around which the various components of off-road vehicle 10 are assembled. Frame assembly 12 is formed of a plurality of structural members that are interconnected by welds, bolts, pins, adhesive and/or other suitable fastening means. Some of the structural members may be tubular members including round or square tubular members that may be hollow and may be formed from metal or metal alloy, such as steel or aluminum. Other structural members may be in the form of stamped sheets such as stamped sheet metal formed from steel or aluminum. Alternatively or additionally, certain structural members may be formed from polymeric materials such as a fiber reinforced polymer composite.

Off-road vehicle 10 includes a plurality of body panels that cover and protect certain components of off-road vehicle 10 such as hood panel 14a, right front fender panel 14b, right door panel 14c, right occupant space panel 14d, right wheel well panel (not shown), right bedside gate outer panel 14e and tailgate outer panel 14f. It should be understood by those having ordinary skill in the art that off-road vehicle 10 has similar body panels on the left side of the vehicle including left front fender panel 14g, left door panel 14h, left occupant space panel 14i, left wheel well panel 14j and left bedside gate outer panel 14k with the body panels of off-road vehicle 10 being collectively referred to herein as body panels 14. Body panels 14 may be formed from sheet metal or metal alloy, such as steel or aluminum, and/or polymeric materials such as fiber reinforced polymer composites. In addition, it should be understood by those having ordinary skill in the art that the right side and the left side of off-road vehicle 10 will be with reference to a forward-facing occupant of off-road vehicle 10 with the right side of off-road vehicle 10 corresponding to the right side of the occupant and the left side of off-road vehicle 10 corresponding to the left side of the occupant. The forward direction of off-road vehicle 10 is indicated by forward arrow 16a and the backward direction of off-road vehicle 10 is indicated by backward arrow 16b in FIGS. 1C and 1D. The forward and backward directions also represent the longitudinal direction of off-road vehicle 10 with the lateral direction of off-road vehicle 10 being normal thereto and represented by a leftward arrow 16c and a rightward arrow 16d in FIGS. 1E and 1F. The backward direction may also be referred to herein as the aftward direction.

Off-road vehicle 10 includes a plurality of ground engaging members depicted as four wheels 18 including front wheels 18a, 18b that are coupled to frame assembly 12 by a front suspension 20 and rear wheels 18c, 18d that are coupled to frame assembly 12 by a rear suspension 22. Frame assembly 12 includes a rollover protection structure 24 that at least partially defines an occupant space 26 within off-road vehicle 10 as best seen in FIGS. 1C and 1D. In the illustrated embodiment, occupant space 26 includes a seating assembly 28 depicted as a pair of bucket seats, namely, a driver seat 28a and a passenger seat 28b in a side-by-side arrangement. In other embodiments, the seating assembly of an off-road vehicle may have a bench seating arrangement. In still other embodiments, the seating assembly of an off-road vehicle may have front and rear seats to accommodate additional occupants such as a total of four, five, six or more occupants.

In FIGS. 1C and 1D, left wheel well panel 14j and the right wheel well panel have been removed from off-road vehicle 10 to better reveal certain additional components of off-road vehicle 10. For example, off-road vehicle 10 has a powertrain 30 that includes an engine 32 shown in FIG. 1C and a transmission 34 shown in FIG. 1D, both of which are coupled to frame assembly 12. Engine 32 may be any type of engine such as a two-stroke engine, a four-stroke engine, an electric motor or other prime mover. Engine 32 may be naturally aspirated or may include a power adder such as a supercharger or a turbocharger. Transmission 34 may be a continuously variable transmission, an electrically variable transmission or other suitable transmission type for varying the ratio of the engine output speed to the input speed to wheels 18. In the illustrated embodiment, off-road vehicle 10 is a four-wheel drive vehicle in which powertrain 30 is operatively coupled to front wheels 18a, 18b via a front differential and to rear wheels 18c, 18d via a rear differential which is coupled to the front differential via a drive shaft. In other embodiments, off-road vehicle 10 may be a two-wheel drive vehicle such as a rear-wheel drive vehicle in which powertrain 30 is coupled to only rear wheels 18c, 18d or a front-wheel drive vehicle in which powertrain 30 is coupled to only front wheels 18a, 18b. In yet other embodiments, off-road vehicle 10 may be selectable between a two-wheel drive mode and a four-wheel drive mode. Off-road vehicle 10 may have an equal vehicle weight distribution between front wheels 18a, 18b and rear wheels 18c, 18d or may have an uneven vehicle weight distribution favoring front wheels 18a, 18b or rear wheels 18c, 18d. For example, it may be desirable to have a weight distribution of 40/60 front to rear, with approximately 40 percent of the vehicle weight bearing on front wheels 18a, 18b and 60 percent of the vehicle weight bearing on rear wheels 18c, 18d. Other suitable front to rear weight distributions may be in the range between 35/65 and 45/55.

Positioned within occupant space 26, off-road vehicle 10 includes a steering wheel 36 that is coupled to front wheels 18a, 18b via a steering linkage 38. In certain embodiments, off-road vehicle 10 may include an electric power steering system that is coupled to steering linkage 38. In other embodiments, off-road vehicle 10 may have hydraulically assisted power steering, electric power steering without a mechanical linkage such as a drive-by-wire system, electric assisted power steering or other suitable steering system. Also disposed within occupant space 26, off-road vehicle 10 includes a gear shift selector 40 that is coupled to transmission 34 and enables the driver to shift off-road vehicle 10 between various driving modes including forward and reverse driving modes.

Positioned aft of seating assembly 28, off-road vehicle 10 includes a cargo box 42 coupled to frame assembly 12. Cargo box 42 may be used to transport large items and/or materials. Cargo box 42 includes a floor 44, to which a tailgate 46, a left bedside gate 48 and a right bedside gate 50 are hingeably coupled. Cargo box 42 is convertible between a box, in which tailgate 46, left bedside gate 48 and right bedside gate 50 are closed, and a flatbed, in which tailgate 46, left bedside gate 48 and right bedside gate 50 are open. FIG. 1E shows cargo box 42 in a box configuration and FIG. 1F shows cargo box 42 in a flatbed configuration.

In addition to cargo box 42, off-road vehicle 10 includes a variety of doors, gates, lids, panels and other pivotable components for a large swath of applications. For example, off-road vehicle 10 may include storage compartment doors such as a glove compartment door or an exterior storage compartment door, fuel tank inlet covers, toolless access panel doors, pivotable windshields, pivotable radiators, passenger doors and/or convertible passenger seats. Because vehicles, especially off-road vehicles, often encounter uneven terrain, these doors, gates, lids, panels and other pivotable components are susceptible to shaking, rattling and other undesired movement, which may dislodge such components from their intended positions. Off-road vehicle 10 utilizes locking hinge assemblies 52a, 52b, 52c, 52d, 52e, 52f to maintain the desired positions of the pivotable components of off-road vehicle 10, particularly when off-road vehicle 10 encounters rough terrain while moving. In the illustrated embodiment, locking hinge assemblies 52a, 52b, 52c, 52d, 52e, 52f are used to hingeably couple one or more of tailgate 46, left bedside gate 48 and/or right bedside gate 50 to floor 44 of cargo box 42. Specifically, left bedside gate 48 is coupled to floor 44 of cargo box 42 via locking hinge assemblies 52a, 52b, tailgate 46 is coupled to floor 44 of cargo box 42 via locking hinge assemblies 52c, 52d and right bedside gate 50 is coupled to floor 44 of cargo box 42 via locking hinge assemblies 52e, 52f. While tailgate 46, left bedside gate 48 and right bedside gate 50 are each illustrated as being hingeably coupled to floor 44 of cargo box 42 using two locking hinge assemblies, tailgate 46, left bedside gate 48 and right bedside gate 50 may each be coupled to floor 44 of cargo box 42 using any number of locking hinge assemblies such as one, three, four or more. Locking hinge assemblies 52a, 52b, 52c, 52d, 52e, 52f may be bolted, welded or otherwise coupled to the subframe underneath floor 44 of cargo box 42. In FIG. 1E, locking hinge assemblies 52a, 52b, 52c, 52d, 52e, 52f are each locked in closed positions to maintain the desired positions of tailgate 46, left bedside gate 48 and right bedside gate 50 in the box configuration of cargo box 42. In FIG. 1F, locking hinge assemblies 52a, 52b, 52c, 52d, 52e, 52f are each locked in open positions to maintain the desired positions of tailgate 46, left bedside gate 48 and right bedside gate 50 in the flatbed configuration of cargo box 42. The load footprint of cargo box 42 expands in the flatbed configuration shown in FIG. 1F such that loading width 54 of cargo box 42 is greater than width 56 between the outer edges of left and right wheels 18a, 18b. Length 58 of cargo box 42 is also increased. The flatbed configuration of cargo box 42 may thus be useful when an expanded footprint is desired for certain cargo loads. While locking hinge assemblies 52a, 52b, 52c, 52d, 52e, 52f are illustrated as hingeably coupling tailgate 46, left bedside gate 48 and right bedside gate 50 to floor 44 of cargo box 42, it will be appreciated that any number of locking hinge assemblies as described in the illustrative embodiments may be used for any door, gate, lid, panel or other pivotable component of off-road vehicle 10.

It should be appreciated that off-road vehicle 10 is merely illustrative of a variety of vehicles that can implement the embodiments disclosed herein. Indeed, any number of locking hinge assemblies 52a, 52b, 52c, 52d, 52e, 52f may be implemented on any ground-based vehicle. Other vehicle implementations can include motorcycles, snowmobiles, snow bikes, all-terrain vehicles (ATVs), utility vehicles including light utility vehicles, utility-terrain vehicles, recreational vehicles including recreational off-highway vehicles, multipurpose off-highway utility vehicles, scooters, automobiles, mopeds, straddle-type vehicles and the like. As such, those skilled in the art will recognize that locking hinge assemblies 52a, 52b, 52c, 52d, 52e, 52f can be integrated into a variety of vehicle configurations. It should be appreciated that even though ground-based vehicles are particularly well-suited to implement the embodiments of the present disclosure, airborne vehicles and devices such as aircraft can also implement the embodiments.

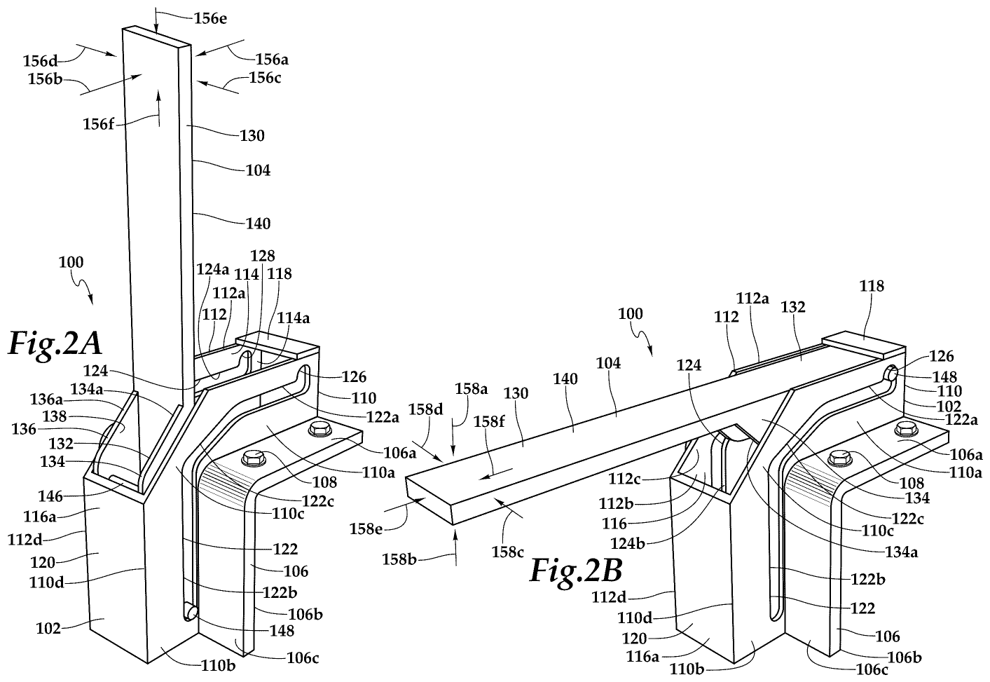

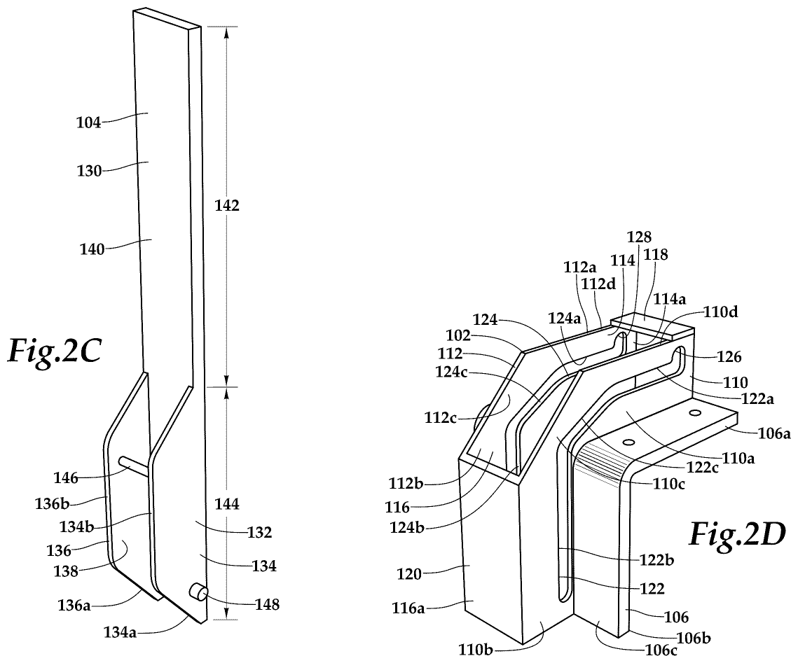

Referring to FIGS. 2A-2D in the drawings, a locking hinge assembly is schematically illustrated and generally designated 100. FIG. 2A shows locking hinge assembly 100 locked in the closed position. FIG. 2B shows locking hinge assembly 100 locked in the open position. As illustrated, locking hinge assembly 100 is a two-part assembly including a hinge base 102 and a hinge tongue 104. FIG. 2C shows hinge tongue 104 in isolation. FIG. 2D shows hinge base 102 in isolation. In certain embodiments, hinge base 102 and/or hinge tongue 104 may each be monolithic, or integral, components formed from the same material. In other embodiments, hinge base 102 and/or hinge tongue 104 may each be assembled from two or more subcomponents formed from the same or different materials. Hinge base 102 and/or hinge tongue 104 may be formed from one or more of a wide variety of materials including a polymer, a metallic material such as steel and/or aluminum or a composite material such as carbon fiber-reinforced polymer. Hinge base 102 and hinge tongue 104 may be manufactured using any additive, subtractive or formative manufacturing technique including, but not limited to, extrusion, machining, 3D printing, laser cutting, stamping, welding or casting as well as others.

Hinge base 102 includes a corner bracket 106 that is used to secure hinge base 102 to the edge of a base component such as floor 44 or the subfloor of cargo box 42 shown in FIGS. 1A-1F. Corner bracket 106 includes horizontal portion 106a and vertical portion 106b. It will be appreciated that the terms “horizontal” and “vertical” are used as relative, not absolute, terms herein, and that in use locking hinge assembly 100 may be rotated or spatially oriented in any direction. As illustrated, horizontal portion 106a of corner bracket 106 is coupled to the base component using one or more fasteners 108. Vertical portion 106b of corner bracket 106 may also be fastened to the base component for additional stability. In other embodiments, horizontal portion 106a and/or vertical portion 106b of corner bracket 106 may be welded or adhered with adhesive to the base component. Projecting from corner bracket 106 are vertical side walls 110, 112. Side walls 110, 112 include horizontally extending portions 110a, 112a, vertically extending portions 110b, 112b and intermediate portions 110c, 112c connecting horizontally extending portions 110a, 112a and vertically extending portions 110b, 112b. Horizontally extending portions 110a, 112a of side walls 110, 112 project from horizontal portion 106a of corner bracket 106. Vertically extending portions 110b, 112b of side walls 110, 112 project from vertical portion 106b of corner bracket 106. Side walls 110, 112 have outer edges 110d, 112d opposite of the inner edges coupled to corner bracket 106. Specifically, outer edges 110d, 112d of horizontally extending portions 110a, 112a of side walls 110, 112 are flat and horizontal, outer edges 110d, 112d of vertically extending portions 110b, 112b of side walls 110, 112 are flat and vertical and outer edges 110d, 112d of intermediate portions 110c, 112c of side walls 110, 112 are flat and diagonal. In other embodiments, all or a portion of outer edges 110d, 112d may be curved.

Side walls 110, 112 partially define horizontal channel 114 and vertical channel 116, which each have a rectangular cross section. Horizontal channel 114 is perpendicular to vertical channel 116. Horizontal channel 114 extends along horizontal portion 106a of corner bracket 106, which acts as a base wall further defining horizontal channel 114. Vertical channel 116 extends along vertical portion 106b of corner bracket 106, which acts as a base wall further defining vertical channel 116. Hinge base 102 includes a horizontal stopping plate 118 coupled to outer edges 110d, 112d of horizontally extending portions 110a, 112a of side walls 110, 112. Stopping plate 118 bridges side walls 110, 112 and partially defines horizontal channel 114. As illustrated, stopping plate 118 covers terminal back end 114a of horizontal channel 114 and covers less than half of the top side of horizontal channel 114 such that horizontal channel 114 has a partially open top side. In other embodiments, however, stopping plate 118 may cover any portion of horizontal channel 114 and extend any distance along outer edges 110d, 112d of horizontally extending portions 110a, 112a of side walls 110, 112. Vertical channel 116 is further defined by a cover wall 120 to form a closed channel with an open top end. In other embodiments, cover wall 120 may cover less than the full length of vertical channel 116 such that outer side 116a of vertical channel 116 is partially open. In yet other embodiments, vertical channel 116 may lack cover wall 120 altogether and therefore have a fully open outer side 116a. Horizontal channel 114 and vertical channel 116 are the same width and are both narrower than the width of corner bracket 106 so as to leave flanging portions 106c of corner bracket 106 exposed. Flanging portions 106c of corner bracket 106 may be used to couple hinge base 102 to the base component.

Side walls 110, 112 each define a guide slot 122, 124, respectively, extending along horizontal channel 114 and vertical channel 116 of hinge base 102. Guide slots 122, 124 include substantially linear horizontal sections 122a, 124a, respectively, extending along horizontal channel 114. All or a portion of horizontal sections 122a, 124a of guide slots 122, 124 are defined by horizontally extending portions 110a, 112a of side walls 110, 112. Guide slots 122, 124 also include substantially linear vertical sections 122b, 124b, respectively, extending along vertical channel 116. All or a portion of vertical sections 122b, 124b of guide slots 122, 124 are defined by vertically extending portions 110b, 112b of side walls 110, 112. Guide slots 122, 124 also include substantially linear diagonal sections 122c, 124c connecting horizontal sections 122a, 124a and vertical sections 122b, 124b. All or a portion of diagonal sections 122c, 124c of guide slots 122, 124 are defined by intermediate portions 110c, 112c of side walls 110, 112. While each guide slot 122, 124 is depicted as including three linear sections, in other embodiments each guide slot 122, 124 may include two, four or more linear sections or may alternatively or additionally include one or more arc sections. The terminal end of each guide slot 122, 124 forms a locking notch 126, 128, respectively. Specifically, locking notches 126, 128 are formed on the terminal ends of horizontal sections 122a, 124a of guide slots 122, 124.

Hinge tongue 104 includes a tongue bracket 130 that is used to secure hinge tongue 104 to a pivotable component such as tailgate 46, left bedside gate 48 or right bedside gate 50 of cargo box 42 shown in FIGS. 1A-1F. Tongue bracket 130 may be coupled to the pivotable component using fasteners, adhesive, welding or any other coupling technique. While tongue bracket 130 is illustrated as having a flat bar shape, tongue bracket 130 may have any shape best suited for coupling tongue bracket 130 to the particular pivotable component for which locking hinge assembly 100 is used. Hinge tongue 104 also includes a tongue base 132. Tongue base 132 includes vertical side walls 134, 136 that partially define a tongue base channel 138 having a rectangular cross section. Each side wall 134, 136 has tapered terminal ends 134a, 136a with a flat edge 134b, 136b interposed therebetween, respectively. Hinge tongue 104 includes a tongue wall 140 that extends through both tongue bracket 130 and tongue base 132 of hinge tongue 104, and which partially defines tongue base channel 138. In the illustrated embodiment, length 142 of tongue bracket 130 is greater than length 144 of tongue base 132. In other embodiments, length 142 of tongue bracket 130 may be less than or equal to length 144 of tongue base 132. Tongue base 132 includes a locking pin 146 disposed in tongue base channel 138. Tongue base 132 also includes guide pins 148 coupled to the flat surfaces of side walls 134, 136 outside of tongue base channel 138. In other embodiments, guide pins 148 may be a single pin extending through tongue base channel 138. Locking pin 146 and guide pins 148 are each depicted as having generally cylindrical shapes, although locking pin 146 and guide pins 148 may form other shapes.

Tongue base 132 has a smaller cross section than horizontal channel 114 and vertical channel 116 so that either channel 114, 116 is large enough to securely receive tongue base 132. In FIG. 2A, tongue base 132 is received by vertical channel 116 of hinge base 102 in the closed position, thereby securing the pivotable component in the closed position. In FIG. 2B, tongue base 132 is received by horizontal channel 114 of hinge base 102 in the open position, thereby securing the pivotable component in the open position. In both the closed position and the open position, guide pins 148 of hinge tongue 104 are slidably engaged with guide slots 122, 124 of hinge base 102.

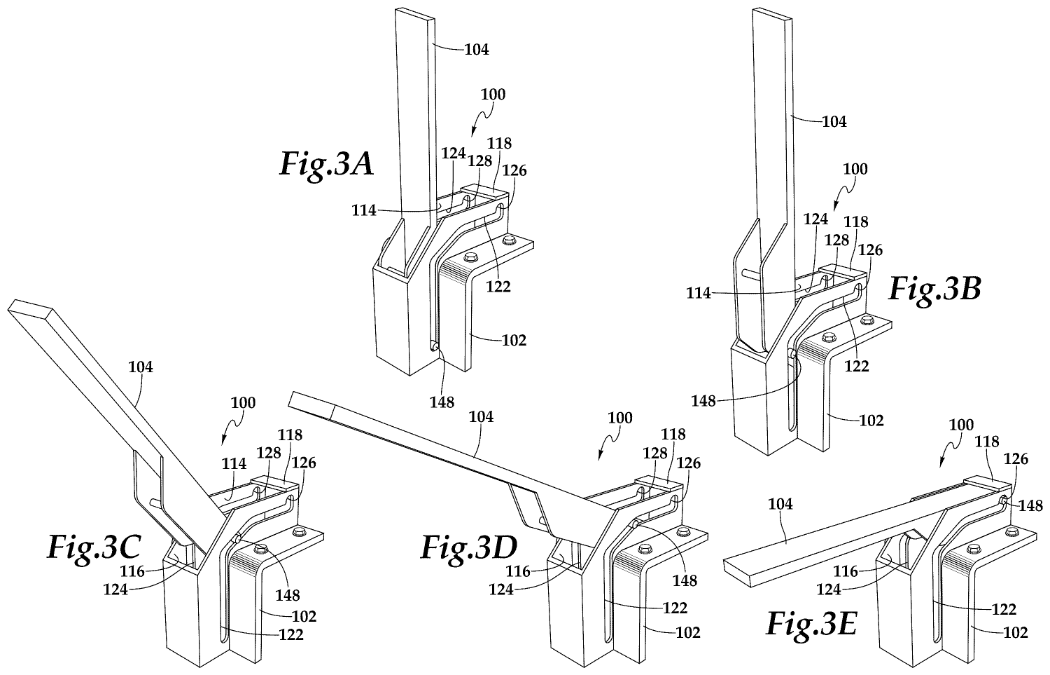

Referring additionally to FIGS. 3A-3E in the drawings, the range of motion of locking hinge assembly 100 between the closed position and the open position including intermediate positions therebetween is shown. In FIG. 3A, hinge tongue 104 is securely received and locked into vertical channel 116 of hinge base 102 in the closed position. In this position, guide pins 148 are located at the bottom terminal ends of vertical sections 122b, 124b of guide slots 122, 124. To disengage the locked closed position, hinge tongue 104 is pulled up and out of vertical channel 116 as shown in FIG. 3B such that guide pins 148 slide from the bottom terminal ends of vertical sections 122b, 124b of guide slots 122, 124 to the top ends of vertical sections 122b, 124b of guide slots 122, 124. In FIG. 3C, hinge tongue 104 is pivoted downward and slid backward as guide pins 148 slide upward along guide slots 122, 124 from vertical sections 122b, 124b of guide slots 122, 124 into diagonal sections 122c, 124c of guide slots 122, 124. In FIG. 3D, hinge tongue 104 continues to pivot downward and slide backward as guide pins 148 slide from diagonal sections 122c, 124c of guide slots 122, 124 into horizontal sections 122a, 124a of guide slots 122, 124. In FIG. 3E, hinge tongue 104 is pivoted into its most downward position and slid into its most backward position such that hinge tongue 104 is securely received and locked into horizontal channel 114 of hinge base 102 in the open position. Guide pins 148 are received by locking notches 126, 128 at the rear terminal ends of horizontal sections 122a, 124a of guide slots 122, 124. Locking notches 126, 128 secure hinge tongue 104 in the open position by preventing hinge tongue 104, and therefore the pivotable component, from sliding forward out of horizontal channel 114 of hinge base 102. Stopping plate 118 also helps to secure hinge tongue 104 in the open position by preventing hinge tongue 104, and therefore the pivotable component, from continuing to pivot downward from the open position, ensuring that the closed and open positions of the pivotable component are generally perpendicular to one another.

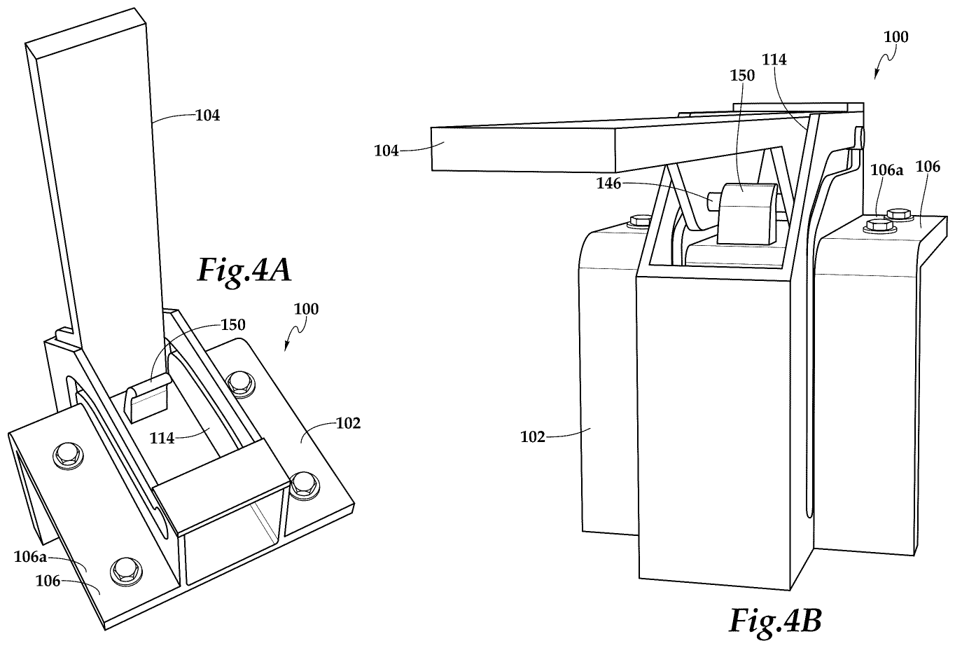

Referring additionally to FIGS. 4A-4B in the drawings, additional views of locking hinge assembly 100 are depicted to illustrate another mechanism by which hinge tongue 104 is secured in the open position. More particularly, hinge base 102 includes a locking latch 150, which projects upward from horizontal portion 106a of corner bracket 106 and is disposed in horizontal channel 114. Locking latch 150 may have a hooked or slightly hooked shape so as to catch locking pin 146 of hinge tongue 104 when hinge tongue 104 is in the open position of FIG. 3E. Locking latch 150 may be partially or fully formed from an elastomeric material such as rubber or other polymer to provide a frictional engagement between locking latch 150 and locking pin 146. By receiving locking pin 146 of hinge tongue 104, locking latch 150 further secures hinge tongue 104, and therefore the pivotable component, from inadvertently sliding forward or pivoting upward from horizontal channel 114 in the open position. In embodiments in which locking latch 150 is formed from an elastomeric material, locking latch 150 elastically bends to selectively engage locking pin 146 when hinge tongue 104 is moved into the open position. When hinge tongue 104 is pulled out of the open position with sufficient force, locking latch 150 elastically bends to release locking pin 146. In other embodiments, a spring latch with a release button may be used in combination with or in lieu of locking latch 150. From the open position in FIG. 3E, hinge tongue 104 may move progressively through the intermediate positions of FIGS. 3D, 3C and 3B and finally back into the closed position of FIG. 3A.

Hinge base 102 secures hinge tongue 104 when hinge tongue 104 is in either vertical channel 116 (the closed position) or horizontal channel 114 (the open position) by opposing various directional loads applied to tongue bracket 130 to which the pivotable component is coupled. As best seen in FIG. 2A, because vertical channel 116 is a closed channel that surrounds tongue base 132 when locking hinge assembly 100 is in the closed position, the walls of the closed channel forming vertical channel 116 oppose directional loads 156a, 156b, 156c, 156d on tongue bracket 130 to maintain the position of the pivotable component to which tongue bracket 130 is coupled. Directional load 156e on tongue bracket 130 into vertical channel 116 is opposed by the terminal ends of vertical sections 122b, 124b of guide slots 122, 124 contacting guide pins 148. A terminal wall (not shown) fully or partially closing the terminal end of vertical channel 116 may also oppose directional load 156e on tongue bracket 130. Tongue base 132 is permitted to slide out of vertical channel 116 in response to directional load 156f on tongue bracket 130, which initiates the transition to the open position of locking hinge assembly 100. As best seen in FIG. 2B, when hinge tongue 104 is secured in horizontal channel 114, hinge tongue 104 does not move in response to directional load 158a on tongue bracket 130 due to contact between flat edges 134b, 136b of tongue base 132 and horizontal portion 106a of corner bracket 106. Stopping plate 118 also prevents tongue base 132 from exiting horizontal channel 114 in response to directional load 158a on tongue bracket 130. Tongue base 132 is permitted to rotate out of horizontal channel 114 in response to directional load 158b on tongue bracket 130 provided that directional load 158b overcomes the resistance force exerted by locking latch 150 on locking pin 146, thereby initiating the transition to the closed position of locking hinge assembly 100. Horizontally extending portions 110a, 112a of side walls 110, 112 contain tongue base 132 within horizontal channel 114 in response to directional loads 158c, 158d. Tongue base 132 is prevented from sliding out of horizontal channel 114 in response to directional loads 158e, 158f on tongue bracket 130 due to the placement of guide pins 148 within locking notches 126, 128 when locking hinge assembly 100 is in the open position. Locking hinge assembly 100 thus provides stable support for the pivotable component to which tongue bracket 130 is coupled in various loading directions.

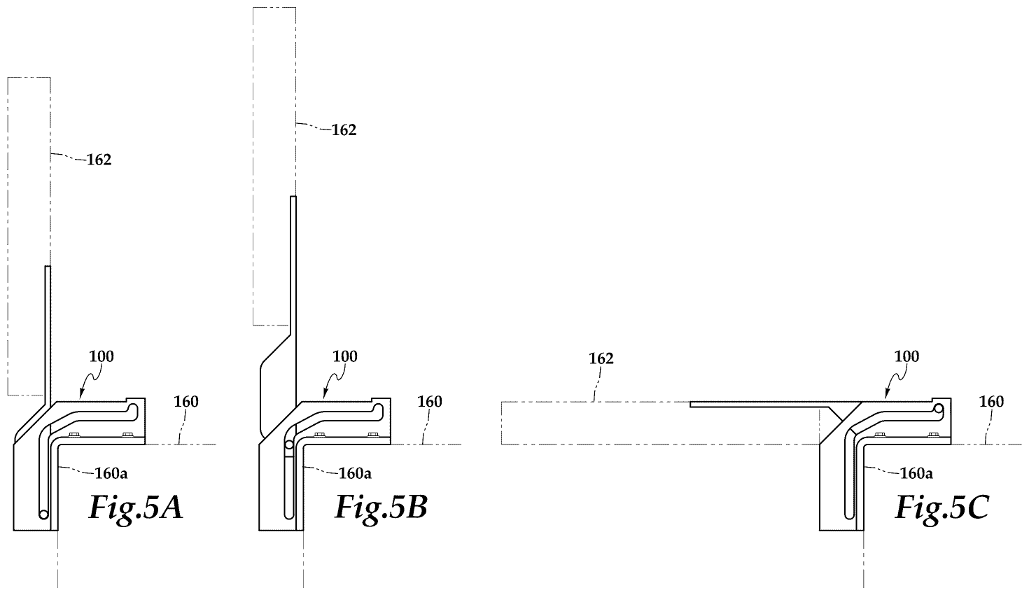

Referring additionally to FIGS. 5A-5C in the drawings, locking hinge assembly 100 is shown coupled to base component 160 and pivotable component 162 to illustrate the wide variety of components and applications with which locking hinge assembly 100 may be used. Pivotable component 162 may be a door, gate, lid, panel or other pivotable component of any vehicle. For example, pivotable component 162 may be tailgate 46, left bedside gate 48 or right bedside gate 50 of cargo box 42 of off-road vehicle 10 in FIGS. 1A-1F. Base component 160 may be the component of the vehicle relative to which pivotable component 162 pivots. For example, base component 160 may be floor 44 of cargo box 42 of off-road vehicle 10 in FIGS. 1A-1F. Locking hinge assembly 100 is shown coupled to edge 160a of base component 160. In the non-limiting example in which pivotable component 162 is tailgate 46, left bedside gate 48 or right bedside gate 50, tailgate 46, left bedside gate 48 or right bedside gate 50 is lifted out of the locked and secure closed position shown in FIG. 5A into the intermediate lifted position shown in FIG. 5B. Tailgate 46, left bedside gate 48 or right bedside gate 50 may then be pivoted downward and slid backwards from the intermediate lifted position shown in FIG. 5B to the locked and secure open position shown in FIG. 5C. In both the closed and open positions, tailgate 46, left bedside gate 48 or right bedside gate 50 is secured from being dislodged or inadvertently moved as off-road vehicle 10 encounters various terrain during operation. It will be appreciated by one of ordinary skill in the art that, depending on the structure and function of pivotable component 162, in some cases the position of pivotable component 162 and locking hinge assembly 100 in FIG. 5A may be considered the open position instead of the closed position and the position of pivotable component 162 and locking hinge assembly 100 in FIG. 5C may be considered the closed position instead of the open position.

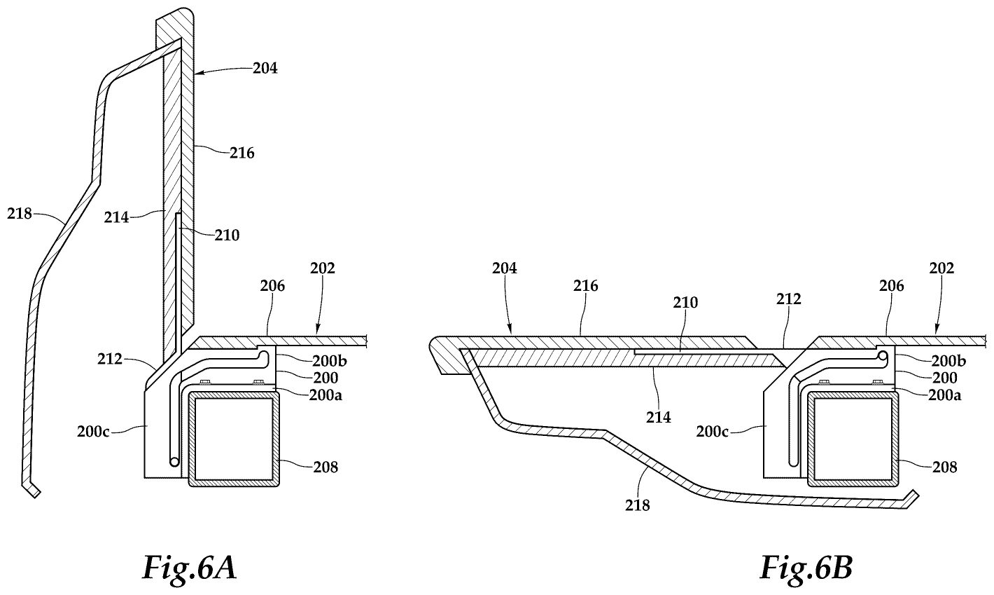

Referring to FIGS. 6A-6B in the drawings, locking hinge assembly 200 is implemented as part of cargo box 202 for a vehicle that includes gate assembly 204 and cargo box floor 206. Cargo box 202 is a non-limiting example of cargo box 42 for off-road vehicle 10 shown in FIGS. 1A-1F and gate assembly 204 and floor 206 are non-limiting examples of tailgate 46, left bedside gate 48 or right bedside gate 50 coupled to floor 44 of cargo box 42. FIG. 6A shows locking hinge assembly 200 and gate assembly 204 in the closed position and FIG. 6B shows locking hinge assembly 200 and gate assembly 204 in the open position. Corner bracket 200a of locking hinge assembly 200 is coupled to a subframe 208 beneath floor 206 of cargo box 202. In the illustrated embodiment, subframe 208 includes a square tube to which corner bracket 200a is coupled. Locking hinge assembly 200 is fully or partially recessed in floor 206 so as to fully or partially conceal horizontal channel 200b of locking hinge assembly 200 from view. In the illustrated embodiment, horizontal channel 200b is interposed between floor 206 and subframe 208. In some embodiments, the top edge of horizontal channel 200b may be substantially flush with floor 206.

Gate assembly 204 is coupled to tongue bracket 210 of hinge tongue 212. Gate assembly 204 includes a gate subframe 214 and an inner bed 216, which sandwich tongue bracket 210. An exterior gate panel 218 is coupled to gate subframe 214 and/or inner bed 216 and protrudes therefrom to substantially conceal vertical channel 200c of locking hinge assembly 200 from view in both the closed and open positions of locking hinge assembly 200 and gate assembly 204. When gate assembly 204 rotates into the open position of FIG. 6B, exterior gate panel 218 slides under subframe 208. Exterior gate panel 218 also protects locking hinge assembly 200 from dust and other debris. Due to the recessed position of locking hinge assembly 200, floor 206 and inner bed 216 of gate assembly 204 are substantially collinear to provide a level surface on which to load cargo onto the vehicle, as best seen in FIG. 6B.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. For example, numerous combinations of the features disclosed herein will be apparent to persons skilled in the art including the combining of features described in different and diverse embodiments, implementations, contexts, applications and/or figures. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A locking hinge assembly for a vehicle, the locking hinge assembly comprising:
a hinge base coupled to a base component of the vehicle, the hinge base defining a vertical channel and a horizontal channel, the vertical channel perpendicular to the horizontal channel; and
a hinge tongue coupled to a pivotable component of the vehicle, the hinge tongue moveable between a plurality of positions including a closed position and an open position, the hinge tongue received by the vertical channel of the hinge base in the closed position, the hinge tongue received by the horizontal channel of the hinge base in the open position.

2. The locking hinge assembly as recited in claim 1 wherein, the vehicle comprises a cargo box including a floor and a gate; and
wherein, the base component comprises the floor of the cargo box and the pivotable component comprises the gate of the cargo box.

3. The locking hinge assembly as recited in claim 2 wherein, the gate comprises a bedside gate.

4. The locking hinge assembly as recited in claim 2 wherein, the gate comprises a tailgate.

5. The locking hinge assembly as recited in claim 1 wherein, the hinge base comprises first and second vertical side walls at least partially defining the vertical and horizontal channels.

6. The locking hinge assembly as recited in claim 5 wherein, the hinge base comprises a horizontal stopping plate bridging the first and second side walls, the stopping plate partially defining the horizontal channel to secure the hinge tongue in the open position.

7. The locking hinge assembly as recited in claim 5 wherein, the first and second side walls each define a guide slot extending along the vertical and horizontal channels of the hinge base; and
wherein, the hinge tongue comprises one or more guide pins slidably engaged with the guide slots, the one or more guide pins slidable along the guide slots as the hinge tongue moves between the plurality of positions.

8. The locking hinge assembly as recited in claim 7 wherein, each guide slot comprises a substantially linear horizontal section extending along the horizontal channel of the hinge base, a substantially linear vertical section extending along the vertical channel of the hinge base and a substantially linear diagonal section connecting the horizontal and vertical sections.

9. The locking hinge assembly as recited in claim 7 wherein, each guide slot has a terminal end forming a locking notch, the locking notches receiving the one or more guide pins in the open position of the hinge tongue, thereby securing the pivotable component in the open position.

10. The locking hinge assembly as recited in claim 1 wherein, the hinge base comprises a locking latch disposed in the horizontal channel; and
wherein, the hinge tongue comprises a locking pin, the locking latch receiving the locking pin in the open position of the hinge tongue to secure the pivotable component in the open position.

11. The locking hinge assembly as recited in claim 10 wherein, the hinge base comprises a corner bracket partially defining the horizontal channel, the locking latch projecting from the corner bracket.

12. The locking hinge assembly as recited in claim 10 wherein, the locking latch comprises an elastomeric material.

13. The locking hinge assembly as recited in claim 1 wherein, the hinge base comprises a corner bracket configured to secure the hinge base to an edge of the base component.

14. The locking hinge assembly as recited in claim 13 wherein, the corner bracket includes vertical and horizontal base walls, the vertical base wall partially defining the vertical channel, the horizontal base wall partially defining the horizontal channel.

15. The locking hinge assembly as recited in claim 13 wherein, the vertical channel is defined by the corner bracket, vertical side walls and a cover wall to form a closed channel with a rectangular cross section and an open top end.

16. An off-road vehicle comprising:
a frame assembly;
a seating assembly coupled to the frame assembly;
a cargo box coupled to the frame assembly aft of the seating assembly, the cargo box comprising a floor and a gate; and
a locking hinge assembly comprising:
a hinge base coupled to the floor of the cargo box, the hinge base defining a vertical channel and a horizontal channel, the vertical channel perpendicular to the horizontal channel; and
a hinge tongue coupled to the gate of the cargo box, the hinge tongue moveable between a plurality of positions including a closed position and an open position, the hinge tongue received by the vertical channel of the hinge base in the closed position, the hinge tongue received by the horizontal channel of the hinge base in the open position.

17. The off-road vehicle as recited in claim 16 wherein, the gate comprises a plurality of gates including a tailgate, a left bedside gate and a right bedside gate;
wherein, the locking hinge assembly comprises a plurality of locking hinge assemblies, each gate coupled to the floor of the cargo box via one or more of the plurality of locking hinge assemblies; and
wherein, the cargo box is convertible between a box in the closed positions of the locking hinge assemblies and a flatbed in the open positions of the locking hinge assemblies.

18. The off-road vehicle as recited in claim 16 wherein, the hinge tongue comprises a tongue bracket and a tongue base, the tongue bracket coupled to the gate of the cargo box, the tongue base receivable by the vertical and horizontal channels of the hinge base.

19. The off-road vehicle as recited in claim 18 wherein, the tongue base comprises vertical side walls at least partially defining a tongue base channel, the tongue base further comprising a locking pin disposed in the tongue base channel.

20. The off-road vehicle as recited in claim 18 wherein, the tongue base has a smaller cross section than the vertical and horizontal channels.
